(19) United States
(12) Patent Application Publication
(10) Pub. No.: US 2026/0024284 A1
(43) Pub. Date: Jan. 22, 2026

(54) SYSTEM AND METHOD FOR 3D HAND-HELD IMAGING

(71) Applicants: Bridget J. Black, Mesquite, TX (US); Chilton Webb, San Antonio, TX (US)

(72) Inventors: Bridget J. Black, Mesquite, TX (US); Chilton Webb, San Antonio, TX (US)

(21) Appl. No.: 18/773,578

(22) Filed: Jul. 16, 2024

(51) Int. Cl. G06T 19/00; G06T 1/00

(52) U.S. Cl. CPC G06T 19/006; G06T 1/0007; G06T 2200/08

(57) ABSTRACT

Disclosed herein is a versatile and cost-effective system for providing three-dimensional imaging of many different subjects utilizing a unique combination of devices. Such a methodology includes, as one non-limiting example, the integration of augmented reality (AR) capabilities of smartphones and/or computers with various imaging modalities (imaging devices), such as ultrasound, microwaves, X-rays, light, and other forms of radiation or energy, in combination with a separate tracking device to correlate actual location of imaged subjects to provide a real-time (or near) three-dimensional (3D) representation of such a subject on demand. The utilization of such combined devices allows for significant versality of the disclosed system through, at least, the ability to remotely transport and utilize such devices together for a 3D view thereof as needed and/or desired. Such a system thus provides effective 3D representations of bodies (humans or animals), geographical sites (for underground determinations, for example), and any other solid form.

### FIELD OF THE DISCLOSURE

This disclosure pertains to a versatile and cost-effective system for providing three-dimensional imaging of many different subjects utilizing a unique combination of devices. Such a methodology includes, as one non-limiting example, the integration of augmented reality (AR) capabilities of smartphone and/or computers with various imaging modalities (imaging devices), such as ultrasound, microwaves, X-rays, light, and other forms of radiation or energy, in combination with a separate tracking device to correlate actual location of imaged subjects to provide a real- or near-real-time three-dimensional (3D) result of such a subject on demand. The utilization of such combined devices allows for significant versality of the disclosed system through, at least, the ability to remotely transport and utilize such devices together for 3D layered representations thereof as needed and/or desired. Such a system thus provides effective 3D representations of bodies (humans or animals), geographical sites (for underground determinations, for example), and any other solid form.

### BACKGROUND OF THE PRIOR ART

Three-dimensional (“3D”) modeling of objects is useful in a wide variety of settings, including modeling anatomical bodies such as bones for research and clinical applications, investigating underground formations, video animation, and machine and equipment design, to name just a few. Unfortunately, present techniques for producing 3D models are rather difficult to practice in typical settings, particularly those requiring large-scale instrumentation and/or base operation machinery (X-rays, MRI machines, ground-based sonar detection equipment, and the like) or, with smaller scale, portable systems, exhibit significant limitations in terms of actual 31) results. For instance, most scanning devices are capable of providing individual layers (or slices) in two-dimensional formats of subject solid forms (a person's bone, for instance) but must undertake multiple layer generation of such individual results to then provide a 3D rendering thereof. Such a result is thus not in a real-time scenario, lacking the capability of offering a user reliable results for study or diagnostic purposes. The creation of a 3D model from digital data sets (such as 3D voxel data or serial, sequenced two dimensional images, as examples) is thus far from providing the most effective and reliable results (and certainly lacking MRI capability, as one example, in terms of detail, accuracy, and reliability). However, as noted above, the provision of a hand-held device that functions to generate 3D results of solid form scanning (internal views, ostensibly) on par with such large-scale equipment (MRI, as an example) has been lacking within such 3D scanning technological areas. Thus, it has proven quite problematic to provide accurate and articulated scanning results utilizing hand-held (or at least portable) devices currently. There is thus a significant need to overcome such deficiencies.

### ADVANTAGES AND SUMMARY OF THE DISCLOSURE

A distinct advantage of the disclosure is the versatile nature of the hand-held and/or portable three-dimensional (3D) scanning system in terms of the ability to provide such reliable results through the utilization of multiple imaging modalities for different applications and scenarios. Another distinct advantage of the disclosure is the ability to utilize such a system in different locations and spaces, particularly in terms of remote and confined maneuverability on demand. Of further advantage is the ability to provide such a hand-held, portable 3D scanning system with highly accurate 3D representations for many different solid forms with real-time feedback. Additionally, the capability of utilizing off-the-shelf portable scanners and/or existing hardware (including large stationary scanners and geological ground penetrating radar) and a smart phone (or like portable device), advantageously allows for a significantly lower cost to practice, particularly in comparison with typical large-scale 3D scanning equipment.

Accordingly, this disclosure is directed to a hand-held augmented reality 3D imaging system comprising a) at least one portable imaging device capable of emitting and receiving multiple forms of radiation or energy; b) at least one computing device equipped with augmented reality features; c) at least one tracking mechanism for determining the position and orientation of the imaging device relative to the computing device; d) image processing and reconstruction software for converting captured data into three-dimensional representations; and e) at least one real-time data transmission module for transmitting captured data for further processing.

As it concerns the noted portable imaging device, such a system component may be stationary or portable in practice and exhibit the capability of emitting and receiving various forms of radiation or energy. Depending on the subject analyzed solid form at issue, such forms of radiation and/or energy may encompass ultrasound waves, microwaves, X-rays, or light as needed. Such a device (or devices) are typical instruments and may be off-the-shelf types, although such a component may be outfitted with sensors for position tracking and orientation purposes in tandem with the other components noted above. Certainly, such a device (or devices) may be custom made, as well, or professionally produced for certain end uses, depending on the specificity necessary for such a desired application. As alluded to above, such a component may constitute multiple devices, as well, to provide varied and/or more in-depth analysis of the subject solid form, as well. For example, two or more users could operate multiple hand scanners, which would be combined to create a larger, single or multiple 3D model(s). Furthermore, such a portable imaging device does not require 3D data creation capability, only the ability to generate a scan of the analyzed structure (solid form) that may be received and translated in combination with the other components thereof to ultimately generate a 3D result.

The computing device of the present disclosure may be any type of computerized machine that includes a camera and/or Augmented Reality features in order to capture video frames, perform detection and orientation of and within the surrounding environment, and possibly overlay AR elements onto the real-world surrounding environment. To that end, smartphones (or devices of similar capability, particularly in terms of maneuverability and manipulation to allow for remote and confined space utilization), laptops, notebooks, iPads, etc., types of computers, and computerized cameras, for example, may be utilized for such a purpose within the disclosed system. As alluded to above, more than one such computing device may be present within such a system, as well, particularly to enhance resolution and accuracy in combination with the imaging device. Also, such a computing device (or devices) computing devices does not require any capability to actually track the portable imaging device itself, only the ability to couple with the imaging device in relation to the camera and/or AR features thereof.

The tracking mechanism of the disclosed system utilizes AR technology to accurately determine the position and orientation of both the hand-held imaging device and the smartphone or computer relative to one another. Such determinations by the tracking mechanism(s) may involve sensor data from the hand-held unit, 3D model detection, light tracking, tracking using motion capture trackers, tracking using VR image tracking (such as HTC Vive lighthouses and trackers), or image tracking techniques using trackable images. Such a tracking mechanism(s) may be situated adjacent to or in close proximity to both the portable imaging device(s) and the computer device(s), or even connected with a portable imaging device within the disclosed system. Such a tracking mechanism(s) allows for detection of orientation relative to both portable imaging and computer devices through the capability of Simultaneous Localization and Mapping (SLAM), a computational problem that involves constructing or updating a map of an unknown environment while simultaneously keeping track of an agent's location within that environment. Such a tracking device thus utilizes SLAM to track the ground, the surroundings, and the camera (computer) together providing a permanent ground plane against which relative computations of the imaging and computer operations are measured. Precision measurements, however, may require appropriately sized tracking mechanisms or at least extensions to the portable imaging device(s) to best ensure proper movements are detected in relation to all components of the system. Basically, it is known that movements over a large surface across a focal point result in similar, measurable movements over the other side of the same focal point and that a large object is easier to track than a small object. In that manner, then, an extension to the portable imaging device(s) allows for improved measured results that permits suitable combined signals between the portable imaging device(s) and the computer device(s) for real-time accuracy and resultant scanning for more realistic 3D representations. The utilization of such SLAM capabilities in combination with the portable imaging and computer device(s) of the disclosed system provides accurate orientation and positioning data for any specific point in time, allowing for synchronization with the video generated from the computer device(s), as well.

The image processing and reconstruction software component of the disclosed system implements algorithms to process data or slices of data from the handheld imaging device, even if the data is not designed to be 3D in nature, store, and convert it into three-dimensional representations. This may involve voxel data processing, point cloud generation, texture mapping, and other 3D reconstruction techniques. Software algorithms and components can recreate the 3D data and track both devices as needed.

The real-time data transmission module facilitates the transmission of captured processed data (or slices thereof) to another device or cloud server, VR/AR/MR/Spatial headset, for further processing, viewing, and/or analysis (including, as non-limiting examples, mixed reality headsets, such as Meta Quest 3 or Apple Vision Pro). Such a module may further allow for viewing of a final 3D scan (from such processed data, for example) on a phone, tablet, and/or computer, in real time, as the subject is actually being scanned. Additionally, or alternatively, such a module may also reconstruct such processed 3D data afterwards with the potential for more precise results (in relation to continued data processing, as an example, over time).

The utilization of such components within the system (and method) disclosed herein allows for significant and unexpectedly effective, versatile, and cost-efficient operations to generate accurate, reliable, and, heretofore, unexplored 3D representation generation technology (particularly with hand-held, portable materials and devices). Typical modern 3D scans, as noted above, rely on expensive and bulky equipment to perform single layer scans, which are then stacked together to create data for a 3D representation of the subject being scanned. This disclosed system (and method) presents an unexpectedly effective and different approach to 3D scanning utilizing, at its core, in one non-limiting embodiment, an inexpensive hand-held ultrasonic scanner. Normally, such a standard device would not be capable of generating a 3D image. There is basically no way to determine positioning and orientation of the scanner in order to generate anything beyond a 2D result, in other words. As alluded to above, such standard technology (hand-held) would likely not create layers of data that neatly stack atop one another since the scan itself is limited in time and actual directional capability over the scanned subject (solid form, for example).

As an example, FIG. 1 herein illustrates a prior art method of providing overlapping images of typical scans. In this illustration, density of the scanned object is measured through such separate scans and recording the objects density at a number of random locations. Again, this simple overlapping of, here, two images, allows for observing points of interest from both of them together and providing a “point cloud” that permits a base measurement, albeit from just two separate two-dimensional views. These limited views are, as discussed above, lacking specific time and spatial orientation to allow for more succinct and accurate views to generate actual and reliable 3D representations. In other words, standard (state of the art, for instance) hand-held imaging devices (ultrasound, X-ray, etc.) scanners may provide an internal scan and thus view of, for example, a patient's bone as well as densities of various bodily substances, but, again, only in terms of generated two-dimensional slices of data, such as shown in prior art FIG. 2 (showing a hand-held imaging device 12, a patient's arm 14, an emitting energy beam 16, and a data slice 18, from within the patient's arm 14). Problematically, as noted previously, such a typical hand-held device simply cannot create a 3D view of such internal data for the reasons noted: it is impossible to know the imaging device's relative position as it concerns such separate scans.

Furthermore, although a stationary smartphone or computer may prove useful to allow for such imaging device results (e.g., the utilization of a video camera in conjunction therewith), in actual practice, such an option is insufficient as a solution to the issue of relative position and distance between scans. In other words, it has been realized that the size of a small scanner would be hard to precisely measure in such a situation. Imprecision of actual object detection, positioning, and orientation overall may be related to the small cross-section of the imaging device (scanner, for example). In particular, this further utilization of a smartphone or like device in combination therewith such a small scanner may create issues with tracking in relation to the size of the imaging device as well and may be subject to drift without an element or further device to provide an anchoring operation (such as provided in prior art FIG. 3, herein). As in prior art FIG. 2, above, there is shown the imaging device 12 with the patient's arm 14, an emission beam 16, and a data slice 18. Additionally, there is shown a stationary phone (computer) device 20 and the sending of signals 22 thereto from the imaging device to provide the data slice image 18. Again, such a method/system is imprecise and insufficient for 3D representation generation due to a lack of accuracy with regard to tracking capability.

Such prior art issues are thus overcome through the disclosure provided herein, particularly through the further utilization of a third element, at least, within the system as disclosed, pertaining, as noted above, to the utilization of AR techniques (SLAM concepts, for instance) and advanced image tracking. Again, this methodology permits simultaneous tracking of the environment, the ground, the surroundings, and the computer (for instance, camera). Such a tracking component thus allows for the necessary relationship in orientation between the imaging device(s) and the computerized device(s) to generate an unexpectedly effective result that provides a full 3D representation in real time of the subject analyzed solid form. In effect, this disclosure presents an alternate method of generating scanned subject data utilizing point clouds and voxel density with hand-held imaging devices and the other system components described above. In terms of embodiments of the disclosed system itself, such are provided in greater detail within the drawings below.

As it concerns actual utilization and applications for such a novel system and method disclosed herein, there are various and myriad analysis and diagnostic tools available in relation to the portable, hand-held disclosure herein. Without limitation, as examples, such a system may apply to the fields of medicine, veterinary science, materials science, botany, sports medicine, image analysis, forensics, and computer science. The multi-modal handheld augmented reality (AR) 3D imaging system and method disclosed herein integrates the augmented reality capabilities of smartphones or computers with various imaging modalities, including ultrasound, microwaves, X-rays, light, and other forms of radiation or energy. This system enables real-time or near real-time three-dimensional representations of subjects such as humans, animals, plants, or inanimate objects (solid forms, for instance). By leveraging AR technology and different imaging technologies, users can capture detailed 3D data in diverse environments and applications, including medical diagnostics, sports diagnostics, biology, botany, geology, veterinary medicine, forensics, industrial inspection, and more, in real time.

As it pertains to medical imaging, for example, the disclosed system and method enables a wide range of diagnostic applications, including detecting blood clots, monitoring fetal development during pregnancy, diagnosing gallbladder disease, evaluating blood flow, guiding needle biopsies, examining breast lumps, guiding needles for biopsy or tumor treatment, checking the thyroid gland, detecting genital and/or prostate problems, assessing joint inflammation (such as synovitis), evaluating metabolic bone disease, determining subclinical atherosclerosis for predicting stroke risks, finding objects embedded in the body (such as, as an example, bullets), detecting internal infections, diagnosing medical injuries without moving the patient, visualizing internal organs (such as the heart, liver, kidneys, bladder, uterus, ovaries, and others), diagnosing conditions such as tumors, cysts, gallstones, and abnormalities in organs, and the like. Other applications may include, again, without limitation, medical assistance, including guiding medical procedures such as biopsies, injections, and aspirations. The real-time imaging provided by ultrasound helps doctors accurately target specific areas and minimize risks. Furthermore, providing such data in real-time to a mixed reality headset (such as Meta Quest 3 or Apple Vision Pro), a doctor or surgeon could see “inside” the patient to assist in surgery, see veins or organs, or see the effects of surgery without the need for large-scale and/or cumbersome devices or instrumentation.

Additional utility in the medical space may include vascular imaging through examining a patient's actual real-time blood circulation and detecting potential problems within blood vessels, showing a real time 3D view of the data for a patient. Such vascular imaging technology may thus evaluate conditions such as deep vein thrombosis (DVT), arterial blockages, blood clots, and aneurysms effectively and reliably. Furthermore, musculoskeletal imaging may be improved through such hand-held scanning techniques utilizing ultrasound to assess injuries or abnormalities in muscles, tendons, ligaments, and joints. Sports medicine may be improved, particularly on the field during an actual game, as an example, with the ability to potentially diagnose conditions like broken bones, tendonitis, muscle tears, fluid accumulation, internal bleeding, and the like. Cardiac imaging may also be improved through such ultrasound techniques, specifically echocardiography, by assessing the structure and function of the heart. The disclosed system thus may aid in diagnosing conditions such as heart valve disorders, congenital heart defects, and heart failure particularly through the ability to provide the user real-time feedback and a 3D view of traditionally 2D data.

As medical uses are quite possible in abundance, the same may be said for veterinary medicine applications, particularly as the overall cost of such a hand-held system as disclosed would be far better as compare with typical diagnostic methods to detect internal maladies. Such as disclosed system would provide veterinarians with the capability to locate areas of pain in animals by detecting increased blood flow, as well as diagnosing various medical conditions. In pregnant animals, it could be used to accurately determine the stage of gestation, assess fetal viability, count the number of fetuses, and detect any potential complications.

Beyond the myriad potential medical applications, there are many other uses, certainly. For instance, industrial inspection capability would allow for non-destructive testing of structures, inspecting pipelines, detecting objects embedded in materials, and detecting flaws or defects in materials such as metals, plastics, and composites. The system as disclosed may further permit identifying cracks, voids, and other imperfections in components like welds, pipes, and structural elements. Environmental monitoring may be facilitated as well through the capability of evaluating environmental conditions and detecting contaminants within certain locations. Geological visualizations would be improved utilizing such a hand-held system as disclosed, particularly as a user may be accorded the ability to instantly “see” underground to locate pipes, oil, water, fossils, or other types of matter with different densities and properties (based upon the type of imaging device used, certainly, including, as examples, ground-penetrating sonar, ultrasound, and other types).

In other words, as provided herein, the disclosed system and/or method provides a wide array of possible analysis and/or diagnosis of myriad objects within myriad areas.

### BRIEF DESCRIPTION OF THE DRAWINGS

The drawings illustrate the design and utility of various embodiments of the present invention. It should be noted that the figures are not drawn to scale and that elements of similar structures or functions are represented by like reference numerals throughout the figures. In order to better appreciate how to obtain the above-recited and other advantages and objects of various embodiments of the invention, a more detailed description of the present inventions briefly described above will be rendered by reference to specific embodiments thereof, which are illustrated in the accompanying drawings. Understanding that these drawings depict only typical embodiments of the invention and are not therefore to be considered limiting of its scope, the disclosure will be described and explained with additional specificity and detail through the use of the accompanying drawings in which:

FIG. 1 illustrates a prior art representation of the capture of two separate two-dimensional scans and the combination of data therefrom.

FIG. 2 illustrates a prior art representation of a typical hand-held imaging device for viewing a slice of medical data.

FIG. 3 illustrates a prior art representation of a hand-held imaging device combined alone with a computer device for generating a singular slice of medical data.

FIG. 4 illustrates one possible embodiment of the presently disclosed system utilizing three separate devices to generate a 3D representation from a hand-held imaging device.

FIG. 5 illustrates a mathematical representation of the particular basis of the tracking measurement of a tracking device within an embodiment of the disclosed system.

FIG. 6 illustrates one possible embodiment of an extension to a hand-held imaging device to accord improved tracking capabilities within the disclosed system.

FIG. 7 illustrates another possible embodiment of an extension to a hand-held imaging device to accord improved tracking capabilities within the disclosed system.

FIG. 8 illustrates yet another possible embodiment of an extension to a hand-held imaging device to accord improved tracking capabilities within the disclosed system.

FIG. 9 illustrates the embodiment of FIG. 6 in terms of utilizing specific orientation measurements in relation to the imaging device and the computer device to generate a real-time 3D representation.

FIG. 10 illustrates the embodiment of FIG. 6 in terms of utilizing specific orientation measurements in relation to the imaging device and the computer device to generate a different, more robust real-time 3D representation.

FIG. 11 illustrates one possible embodiment of a hand-held imaging device.

FIG. 12 illustrates one possible embodiment of a hand-held imaging device including a particular extension for tracking purposes, according to the illustrated embodiments.

FIG. 13 provides a system architecture for an embodiment of the disclosure.

### DETAILED DESCRIPTION OF THE DRAWINGS AND PREFERRED EMBODIMENTS

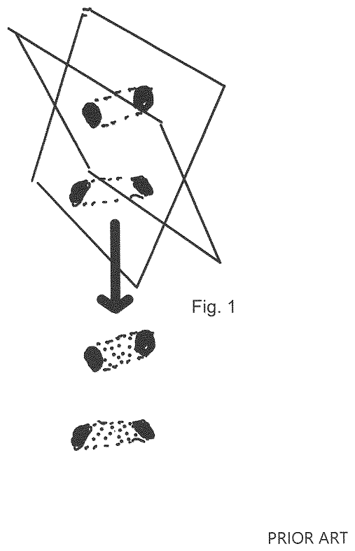

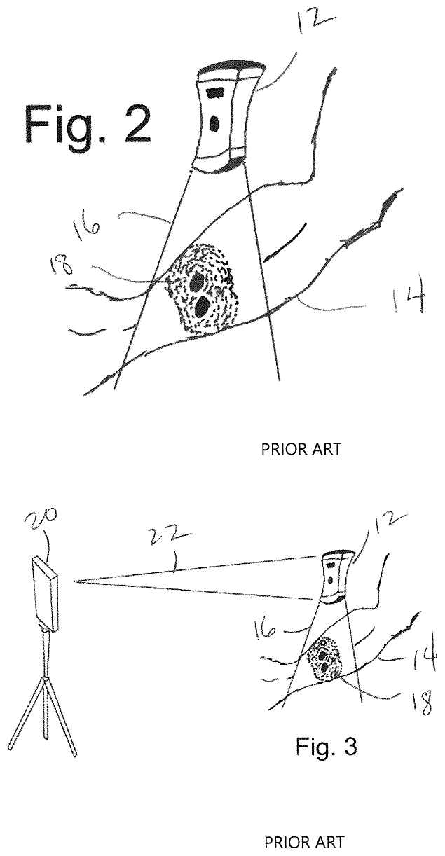

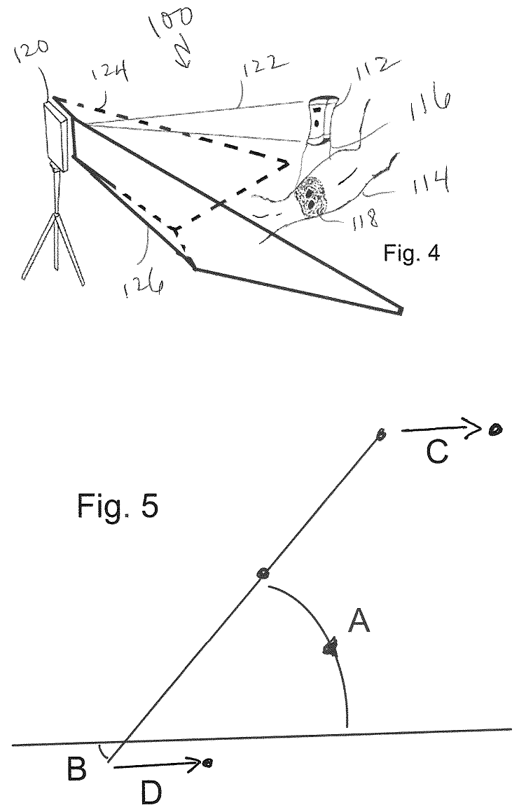

All the features of this invention and its preferred embodiments will be described in full detail in connection with the following illustrative, but not limiting, drawings and examples. FIG. 4 provides an illustration of one possible embodiment of the disclosed system, particularly utilizing ultrasound imaging technology for medical purposes. The system 100 includes an imaging device 112 scanning a patient's arm 114 with an emitting ultrasound energy 116 to generate data of the patient's arm 118. As opposed to the prior art systems described above in FIGS. 1, 2, and 3, a computer device 120 (smartphone, computer, with camera and/or AR) including advanced image tracking 124 to provide a permanent ground plane against which relative computations may be made 126. The computer device 120 receives data 122 from the hand-held imaging device 112. The system 100 further includes image processing and reconstruction software (not illustrated) within the computer device 120 for converting captured data into three-dimensional representations, and a real-time data transmission module (not illustrated) for transmitting captured data for further processing.

The tracking device implements simple geometry, as presented in FIG. 5, as a means to accurately determine the proper orientation and positioning data of both the AR and imaging devices. In this manner, movements of such a imaging device 112 in relation to the AR device relates to a focal point each device is configured around. The Angle A is thus equal to Angle B, while distance C is equal to distance D. Utilizing such a geometrical function allows for both devices to be oriented similarly and in real-time (simultaneously) to synchronize such dimensional measurements with video from the imaging device and recorded through the AR device.

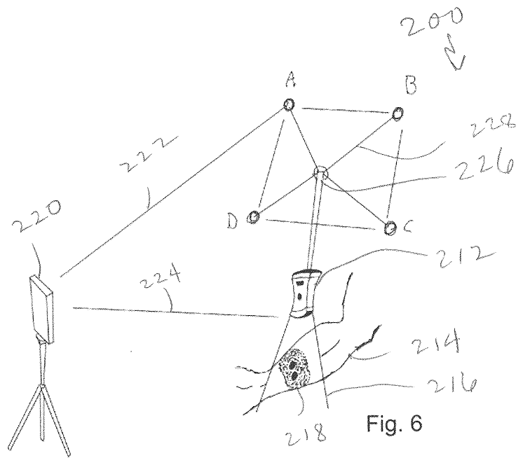

Even with such a functional platform and system, there are limitations to the effectiveness of the FIG. 4 embodiment in relation to accuracy, at least, of orientation between the imaging device 112 and the computer device 120. To the end, FIGS. 6-8 provide embodiments that encompass different ways to improve upon such tracking capabilities through the utilization of extended structures from such a hand-held imaging device. For instance, within the system 200, the imaging device 212 includes an extension 226 with four equidistant ball structures A, B, C. D on rods 228 that basically create a larger article with known dimensions attached to the imaging device 212 (scanner). Such an extension moves in relation to the imaging device 212 movements thereby providing a geometric basis for equating (or at least converting) such distances and angles of movement in relation to the ground and computer device 220 for both the scanner 212 and the extension 226. The tracking movements of the scanner 224 and the extension 222 thus provide such orientation reliability to permit a more robust image of a patient's arm 214 and the 3D information from inside 218. As above, software within the computer device 220 converts the data 218 generated from the imaging device and the AR computer device 220 in relation to the tracking mechanism capabilities to generate such a 3D representation in real-time (such a computer device may be a simple smartphone with augmented reality capabilities, as a non-limiting example, possibly employing LIDAR for such a purpose).

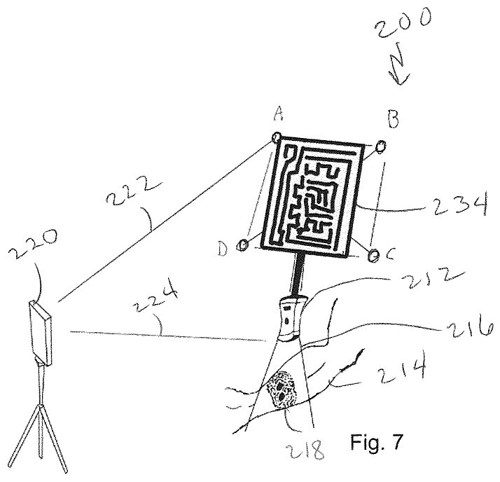

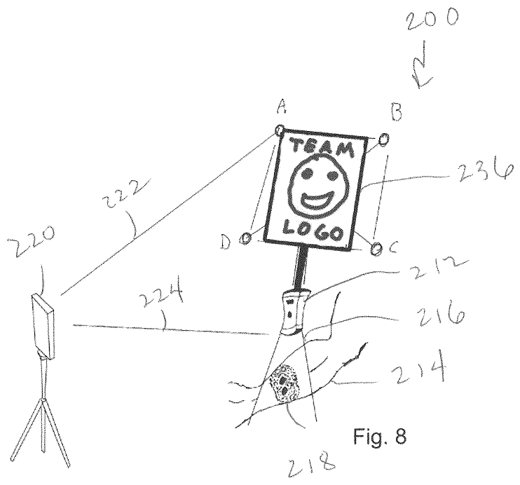

Such is reviewed within a video module on demand (not illustrated) as well. FIG. 7 thus shows a possible embodiment of the system 200 through inclusion of a large extension 234 with, for convenience purposes, a QR code thereon that may be utilized, as one non-limiting example, to provide information and directions for a user or users during operation thereof. FIG. 8 shows a further possible embodiment with an extension 236 including, again, as a non-limiting example, a logo or representation of a sports team (or like organization) as an identifier for branding purposes. This could be used on a football field, for example, to determine if a player's arm or leg has been broken.

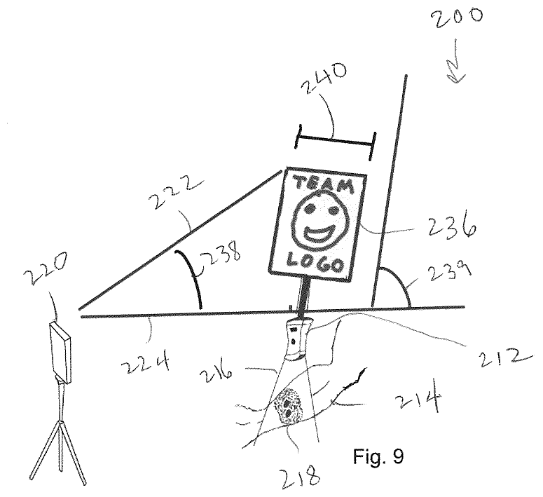

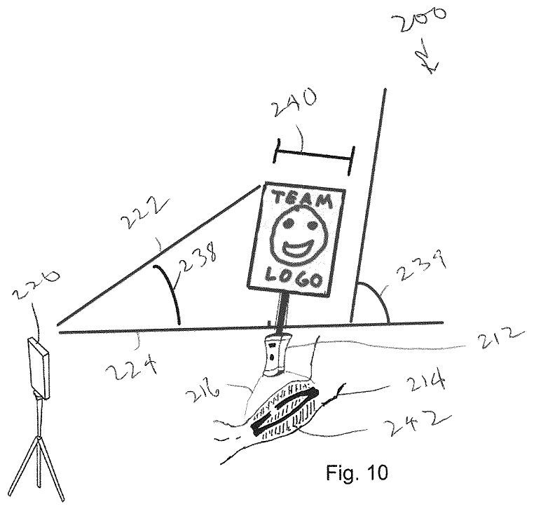

As it concerns such an extension, it is important to state that any type of device or article exhibiting known dimensions may be connected to or with the scanner (imaging device). This embodiment would enable us to quickly determine accurate distance and rotation changes, as well as accurate position information about the scanner attached to the end of the points. As shown in FIG. 9, for instance, an embodiment utilizing the extension's orientation and position 238, 239, 240, and using slightly more extensive (3D) math than FIG. 5 above, such a configuration may be employed to calculate a more precise orientation and position of the scanner 212, in other words. This will result, as shown in FIG. 10, in the generation of a density point cloud, which can be represented in 3D, allowing the user to “paint” a 3D image 242 of the scanned object simply by moving the scanner across it, while it is being monitored by augmented reality software, custom reconstruction software (likely point cloud reconstruction, volumetric reconstruction, Gaussian Splatting or spatial video), and a device running it.

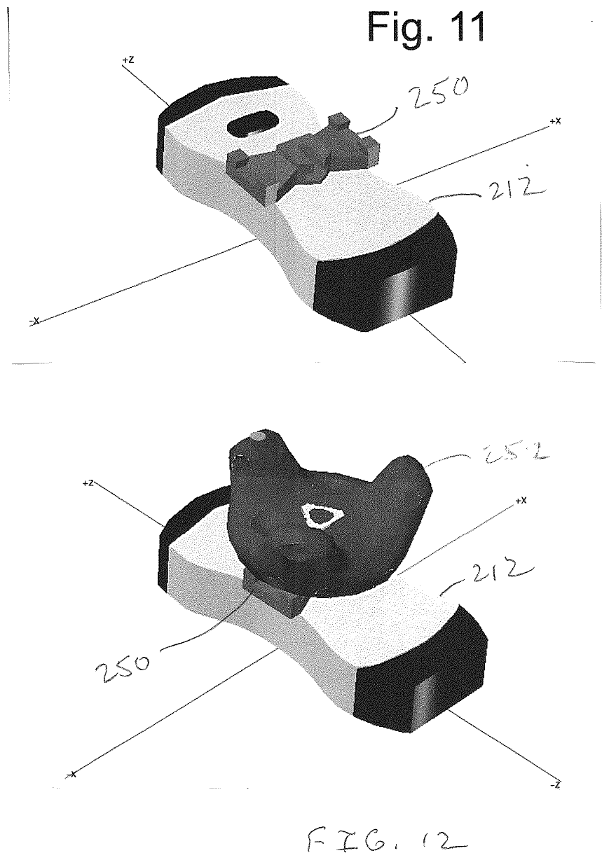

In another embodiment, as shown in FIGS. 11 and 12, the handheld scanner 212 may bed be attached to a 3D motion tracking controller 252, like an HTC Vive Tracker, as a non-limiting example, via a compatible mount 250. This, along with the tracking device (such as, again as a non-limiting device, HTC Vive Lighthouse) and custom software, would facilitate scanning anything without additional setup beyond the initial tracking device setup. Such a simple configuration would exhibit the additional benefit of the processing power of a full desktop computer, as opposed to a smart phone, through wireless connection capability.

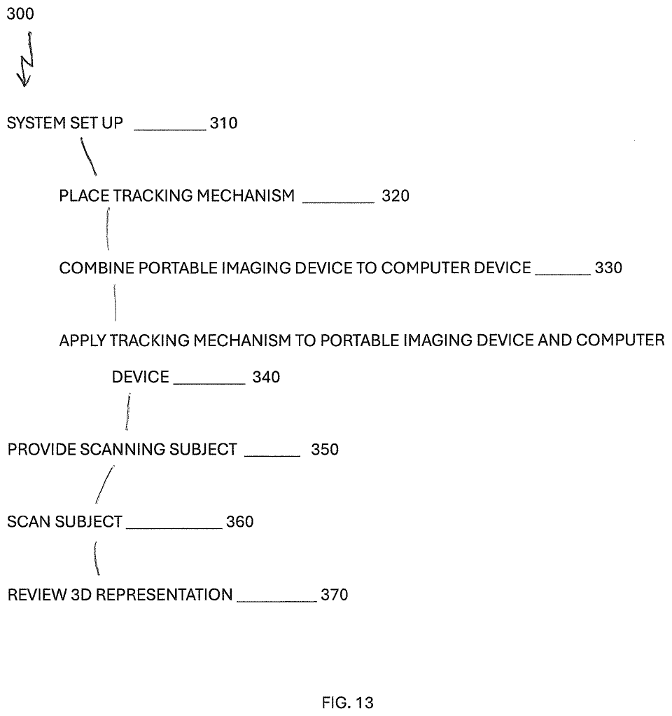

FIG. 13 provides an overall illustration of the method and system architecture 300 undertaken within the disclosure. Such a method 300 involves the initial set up of components 310, including the placement of a tracking mechanism 320 in relation combining a portable imaging device to a computer device 330 (with the computer device including the AR technology as discussed above). The tracking mechanism is then applied to the portable imaging device and computer device 340 to allow for utilization of the method for scanning of an object. Such objects, as noted above, may be of any type of three-dimensional structures themselves, ostensibly allowing for scanning thereof to determine internal structures thereof through such things as density comparisons and the like. The scanning device (imaging device) may be of any type in relation to any such scanned objects and thus may, as discussed above, provide different ultrasound, microwaves, X-rays, light, sonar, and the like. Once the to-be-scanned object is provided 350, the scanner (which may include an extension as discussed above) is operated in conjunction with the computer device (AR, for instance) and the tracking device to therefore scan the object 360. From this undertaking, the scanned data is correlated with and/or processed by the computer device in relation to the movements tracked thereof by the tracking device (including, if present, those of the extension) and real-time computations are generated in relation to the data from the overall scan. Such data of the scanned object are then transferred to image processing and reconstruction software present within the computer device, which thereby converts such scanned captured data into 3D representations of the scanned object (or more particularly, perhaps, the interior structures thereof such a scanned object). The 3D representations are then further transferred through a real-time data transmission module for transmitting captured data for viewing thereof (and possibly further processing). Such a system or method 300 may be utilized for any type of typically scanned solid form (body, ground, edifice, etc.) on demand. Such a data transmission module (and further viewing device) may be selected from, without limitation, a phone or tablet or a computer, in real time, as the subject is being scanned, reconstructed thereafter, if desired.

The multi-modal handheld AR 3D imaging system disclosed herein thus represents a significant advancement in imaging technology, offering a versatile and portable solution for capturing three-dimensional data in real-time. By integrating AR capabilities with various imaging modalities, this innovation empowers users across industries to visualize and analyze spatial information with unprecedented accuracy and efficiency.

It should be understood that various modifications within the scope of this disclosure can be made by one of ordinary skill in the art without departing from the spirit thereof. It is therefore wished that this disclosure be defined by the scope of the appended claims as broadly as the prior art will permit, and in view of the specification if need be.

What is claimed is:

1. A hand-held augmented reality 3D imaging system comprising:
a) at least one portable imaging device capable of emitting and receiving multiple forms of radiation or energy;
b) at least one computing device equipped with augmented reality features;
c) at least one tracking mechanism for determining the position and orientation of the imaging device relative to the computing device;
d) image processing and reconstruction software for converting captured data into three-dimensional representations; and
e) at least one real-time data transmission module for transmitting captured data for further processing.

2. The system of claim 1, wherein said at least one portable imaging device utilizes ultrasound waves for imaging.

3. The system of claim 1, wherein said at least one portable imaging device utilizes microwaves for imaging.

4. The system of claim 1, wherein said at least one portable imaging device utilizes X-rays for imaging.

5. The system of claim 1, wherein said at least one portable imaging device utilizes light for imaging.

6. The system of claim 1, wherein said at least one tracking mechanism utilizes sensor data from said at least one portable imaging device for determining position and orientation.

7. The system of claim 1, wherein said at least one tracking mechanism utilizes image tracking techniques for determining position and orientation.

8. The system of claim 1, wherein said at least one portable imaging device comprises sensors for tracking its position and orientation.

9. The system of claim 1, wherein said image processing and reconstruction software employs voxel data processing for generating three-dimensional representations.

10. The system of claim 1, wherein said at least one real-time data transmission module transmits captured data to a cloud server for further processing and analysis.

11. A method for generating a three-dimensional representation of a subject using a handheld augmented reality 3D imaging system, comprising:
a) emitting radiation or energy from at least one portable imaging device;
b) capturing video frames and overlaying augmented reality elements on a computing device;
c) determining the position and orientation of said at least one imaging device relative to said computing device;
d) processing captured data to generate a three-dimensional representation; and
e) transmitting captured data for further processing.

12. The method of claim 11, wherein the radiation or energy emitted from said at least one portable imaging device comprises ultrasound waves.

13. The method of claim 11, wherein the radiation or energy emitted from said at least one portable imaging device comprises microwaves.

14. The method of claim 11, wherein the radiation or energy emitted from said at least one portable imaging device comprises X-rays.

15. The method of claim 11, wherein the radiation or energy emitted from said at least one portable imaging device comprises light.

16. The method of claim 11, wherein the radiation or energy emitted from said at least one portable imaging device is comprised of data created from a secondary device.

17. The method of claim 11, wherein the radiation or energy emitted from said at least one portable imaging device comprises ground penetrating radar.
